(19) United States
(12) Patent Application Publication
(10) Pub. No.: US 2018/0030337 A1
(43) Pub. Date: Feb. 1, 2018

(54) LOW DENSITY CERAMIC PROPPANT AND METHOD FOR PRODUCTION THEREOF

(71) Applicant: Imerys Oilfield Minerals, Inc., Roswell, GA (US)

(72) Inventors: Robert J. PRUETT, Milledgeville, GA (US); Lisa BUTTITTA, Milledgeville, GA (US); Laura JOHNSEN, Spring, TX (US)

(21) Appl. No.: 15/553,743

(22) PCT Filed: Feb. 22, 2016
(86) PCT No.: PCT/US16/18871

§ 371 Date: Aug. 25, 2017

Related U.S. Application Data
(60) Provisional application No. 62/126,012, filed on Feb. 27, 2015.

(51) Int. Cl. C09K 8/80; C04B 33/13; C04B 33/32; C04B 33/04

(52) U.S. Cl. CPC C09K 8/80; C04B 33/04; C04B 33/131; C04B 33/1305; C04B 33/32; C04B 2235/349; C04B 2235/3427; C04B 2235/48; C04B 2235/528; C04B 2235/5436; C04B 2235/5445; C04B 2235/656; C04B 2235/77

(57) ABSTRACT

A method of making a sintered ceramic proppant may include providing a ceramic precursor material comprising kaolin clay, 0.2%-2% by weight alkali silicate, and not more than 0.05% by weight polymeric anionic dispersant. The method may further include pelletizing the ceramic precursor and sintering the ceramic precursor pellets for form a sintered ceramic proppant having a specific gravity ranging from 2.40 to 2.57.

### CLAIM OF PRIORITY

This PCT International Application claims the benefit of priority of U.S. Provisional Application No. 62/126,012, filed Feb. 27, 2015, the subject matter of which is incorporated herein by reference in its entirety.

### FIELD OF THE DISCLOSURE

The present disclosure relates to proppants and anti-flowback additives including kaolin clay for use in fracturing operations, and more particularly, to sintered ceramic proppants including kaolin clay and methods for making sintered ceramic proppants including kaolin clay.

### BACKGROUND

Naturally occurring deposits containing oil and natural gas are located throughout the world. Given the porous and permeable nature of the subterranean structure, it is possible to bore into the earth and set up a well where oil and natural gas are pumped out of the deposit. These wells are large, costly structures that are typically fixed at one location. As is often the case, a well may initially be very productive, with the oil and natural gas being pumpable with relative ease. As the oil or natural gas near the well bore is removed from the deposit, other oil and natural gas may flow to the area near the well bore so that it may be pumped as well. However, as a well ages, and sometimes merely as a consequence of the subterranean geology surrounding the well bore, the more remote oil and natural gas may have difficulty flowing to the well bore, thereby reducing the productivity of the well.

To address this problem and to increase the flow of oil and natural gas to the well bore, a technique may be employed of fracturing the subterranean area around the well to create more paths for the oil and natural gas to flow toward the well bore. This fracturing may be performed by hydraulically injecting a fracturing fluid at high pressure into the area surrounding the well bore. This fracturing fluid is thereafter removed from the fracture to the extent possible so that it does not impede the flow of oil or natural gas back to the well bore. Once the fracturing fluid is removed, however, the fractures may tend to collapse due to the high compaction pressures experienced at well-depths, which may exceed 20,000 feet.

To reduce the likelihood of the fractures closing, a propping agent, also known as a “proppant” or “anti-flowback additive,” may be included in the fracturing fluid, so that as much of the fracturing fluid as possible may be removed from the fractures while leaving the proppant behind to hold the fractures open. As used in this application, the term “proppant” refers to any non-liquid material that is present in a proppant pack (a plurality of proppant particles) and provides structural support in a propped fracture. “Anti-flowback additive” refers to any material that is present in a proppant pack and reduces the flowback of proppant particles but still allows for production of oil at desired rates. The terms “proppant” and “anti-flowback additive” are not necessarily mutually exclusive, so a single particle type may meet both definitions. For example, a proppant particle may provide structural support in a fracture, and it may also be shaped to have anti-flowback properties, allowing it to meet both definitions.

Because there may be extremely high closing pressures in fractures, it may be desirable to provide proppants and anti-flowback additives that have a high crush resistance. For example, the useful life of the well may be shortened if the proppant particles break down, allowing the fractures to collapse and/or clog with “fines” created by the broken-down proppant particles. For this reason, it may be desirable to provide proppants that are resistant to breakage, even under high crush pressures.

In addition, it may also be desirable to provide a proppant or anti-flowback additive that packs well with other proppant particles and the surrounding geological features, so that the nature of this packing of particles does not unduly impede the flow of the oil and natural gas through the fractures. For example, if the proppant particles become too tightly packed and create low porosity, they may actually inhibit the flow of the oil or natural gas to the well bore rather than increase it.

The nature of the packing may also affect the overall turbulence generated as the oil or natural gas flows through the fractures. Too much turbulence may increase the flowback of the proppant particles from the fractures toward the well bore, which may undesirably decrease the flow of oil and natural gas, contaminate the well, cause abrasion to the equipment in the well, and/or increase the production cost as the proppants that flow back toward the well must be removed from the oil and natural gas. In addition, too much turbulence may also increase a non-Darcy flow effect, which may ultimately result in decreased conductivity.

As resources become more scarce, the search for oil and natural gas may involve penetration into deeper geological formations, and the recovery of the such resources may become increasingly difficult. Therefore, there may be a desire to provide proppants and anti-flowback additives that have an excellent conductivity and permeability under extreme conditions. In addition, there may be a desire to provide proppants and anti-flowback additives formed from less costly or more prevalent materials that still provide one or more desirable characteristics for propping fractures in modern wells.

### SUMMARY

According to one aspect, a method of preparing a sintered ceramic proppant may include providing a ceramic precursor material such as kaolin clay, 0.2%-2% by weight alkali silicate, and not more than 0.05% by weight polymeric anionic dispersant, pelletizing the ceramic precursor; and sintering the ceramic precursor pellets for form a sintered ceramic proppant having a specific gravity ranging from 2.40 to 2.57. The ceramic precursor is a mixture or blend of one or more kaolin or kaolinitic ore components.

According to one aspect, the ceramic precursor can have a particle size distribution such that greater than 85% of the particles have an equivalent spherical diameter of less than 2 microns as measured by Sedigraph. For example, the ceramic precursor can have a particle size distribution such that greater than 90% of the particles have an equivalent spherical diameter of less than 2 microns as measured by Sedigraph, such as for example greater than about 92%, greater than about 94%, greater than about 95%, or even greater than about 96%.

In another aspect, the ceramic precursor can have a particle size distribution such that greater than 20% of the particles have an equivalent spherical diameter of less than 0.25 microns as measured by Sedigraph. For example, the ceramic precursor can have a particle size distribution such that greater than 25%, greater than 30%, or greater than 40% of the particles have an equivalent spherical diameter of less than 0.25 microns as measured by Sedigraph.

In another aspect, the ceramic precursor can have a particle size distribution such that not greater than 10% of the particles have an equivalent spherical diameter of greater than 10 microns as measured by Sedigraph. For example, the ceramic precursor can have a particle size distribution such that not greater than 5% or not greater than 2% of the particles have an equivalent spherical diameter of greater than 10 microns as measured by Sedigraph.

According to a further aspect, the kaolin clay may have an Al₂O₃ content ranging from about 42% by weight to about 46% by weight on a fired basis, for example, an Al₂O₃ content ranging from about 43% by weight to about 45% by weight on a fired basis. Expressing chemistry on the fired basis assumes all moisture and losses on ignition at 1050° C. are 0.0%.

In another aspect, the kaolin clay can have a K₂O content ranging from about 0.005% by weight to about 0.23% by weight on a fired basis, such as for example ranging from about 0.01% by weight to about 0.08% by weight on a fired basis or about 0.01% by weight to about 0.06% by weight on a fired basis.

In another aspect, the ceramic precursor comprises a kaolin clay having a shape factor of less than about 15, or less than about 10. For example, the shape factor may range from about 2 to about 15, from about 2 to about 10, or from about 5 to about 8.

In another aspect, the slurry includes at least one dispersant. In one aspect, the slurry includes not more than 0.05% polymeric anionic dispersant, such as for example not more than 0.04% or not more than 0.03 polymeric anionic dispersant. In another aspect, the slurry can include from 0.5%-1% by weight of alkali silicate.

In another aspect, the sintered ceramic proppant can have a specific gravity greater than about 2.50. In another aspect, the sintered ceramic proppant can have a specific gravity less than about 2.50.

In another aspect, the sintered ceramic proppant can have a bulk density ranging from about 1.25 g/cm³ to about 1.45 g/cm³, such as for example ranging from about 1.30 g/cm³ to about 1.40 g/cm³.

According to yet another aspect, the crush strength measured under ISO 13503-2 of the sintered ceramic proppant at 7,500 psi may be less than about 10% fines by weight, for example for a 30/50 mesh size proppant. For example, the crush strength measured under ISO 13503-2 of the sintered ceramic proppant at 7,500 psi may be less than about 6% fines by weight, or less than about 4% fines by weight.

In one aspect, the pelletizing can be accomplished using a “wet” method, such as for example using a spray fluidizer. In another aspect, the pelletizing can be accomplished using a “dry” method, such as using an Eirich mixer.

According to another aspect, the kaolin clay may include a blend of a first kaolin clay having a particle size distribution such that greater than 90% of the particles have an equivalent spherical diameter of less than 2 microns as measured by Sedigraph and a second kaolin clay having a particle size distribution of the kaolin clay is such that from 82% to 94% of the particles have an equivalent spherical diameter of less than 2 microns as measured by Sedigraph.

According to another aspect, the kaolin clay may include a blend of a first kaolin clay including not greater than about 46% by weight Al₂O₃ and a second kaolin clay including greater than about 47% by weight Al₂O₃. For example, the second kaolin clay may have an Al₂O₃ content ranging from about 49% to about 55%, or from about 50% to about 53%. The blend may include at least about 10% by weight of the first kaolin clay, for example, at least about 25% by weight of the first kaolin clay.

According to still another aspect, the kaolin clay may include a blend of a first kaolin clay including less than about 0.1% by weight K₂O and a second kaolin clay including greater than about 0.1% by weight K₂O. The blend may include at least about 10% by weight of the first kaolin clay, for example, at least about 25% by weight of the first kaolin clay.

According to yet another aspect, the kaolin clay may include a blend of a first kaolin clay having a shape factor of less than about 15 and the second kaolin clay having a shape factor of greater than about 20.

It is to be understood that both the foregoing general description and the following detailed description are exemplary and explanatory only and are not restrictive of the invention.

### BRIEF DESCRIPTION OF THE DRAWING

FIG. 1 is a schematic diagram of an exemplary process for making exemplary sintered ceramic proppants consistent with exemplary methods disclosed herein.

FIG. 2 is a graph illustrating the change in absolute density of pellets prepared in accordance with Example 1 at a range of different sintering temperatures.

### DESCRIPTION OF EXEMPLARY EMBODIMENTS

Reference will now be made to exemplary embodiments.

Conventional ceramic proppants often have an absolute density measure by API/ISO 13503-2 between 2.57 and 2.79 g/cm³. For example, products manufactured using a wet process, such as a spray fluidizer, can have absolute densities between 2.57 and 2.73. Other examples of products manufactured using the dry process can often have absolute densities between 2.66 and 2.79.

In one aspect, the invention provides a low density ceramic proppant having an absolute density less than 2.57 and greater than 2.40. According to some embodiments, the sintered ceramic proppant may have a specific gravity greater than about 2.45, or a specific gravity greater than about 2.48, for example greater than about 2.5. According to other embodiments, the sintered ceramic proppant may have a specific gravity less than 2.55, for example less than 2.52. In yet another aspect, the sintered ceramic proppant may have a specific gravity ranging from 2.40 to 2.48, from 2.40 to 2.52, or from 2.40 to 2.55. In another aspect, the sintered ceramic proppant may have a specific gravity ranging from 2.44 to 2.57, from 2.48 to 2.57, or from 2.52 to 2.57.

In another aspect, the sintered ceramic proppant can have a bulk density ranging from about 1.25 g/cm³ to about 1.45 g/cm³, such as for example ranging from about 1.30 g/cm³ to about 1.40 g/cm³. For example, the sintered ceramic proppant may have a bulk density greater than about 1.30 g/cm³, greater than about 1.32 g/cm³, greater than about 1.35 g/cm³, or greater than about 1.38 g/cm³. For example, the sintered ceramic proppant may have a bulk density ranging from about 1.35 g/cm³ to about 1.45 g/cm³.

As will be appreciated by those skilled in the art, the particle size distribution of a particulate material such as the kaolin clay may be determined by measuring the sedimentation speeds of the dispersed particles of the particulate material under test through a standard dilute aqueous suspension using a SEDIGRAPH® instrument (e.g., SEDIGRAPH 5100® obtained from Micromeritics Corporation, USA). The size of a given particle may be expressed in terms of the diameter of a sphere of equivalent diameter (i.e., the “equivalent spherical diameter” or esd), which sediments through the suspension, which may be used to characterize the particulate material. The SEDIGRAPH records the percentage by weight of particles having an esd less than a particular esd value, versus that esd value.

According to one aspect, the ceramic precursor includes kaolin that can have a particle size distribution such that greater than 85% of the particles have an equivalent spherical diameter of less than 2 microns as measured by Sedigraph. For example, the ceramic precursor can have a particle size distribution such that greater than 90% of the particles have an equivalent spherical diameter of less than 2 microns as measured by Sedigraph, such as for example greater than about 92%, greater than about 94%, greater than about 95%, or even greater than about 96%. In another example, the ceramic precursor includes kaolin that has a particle size distribution such that between 85% and 98% of the particles have an equivalent spherical diameter of less than 2 microns as measured by Sedigraph, such as for example such that from 87% to 96%, 85% to 90%, from 90% to 95%, or from 87% to 95% of the particles have an equivalent spherical diameter of less than 2 microns as measured by Sedigraph.

In another aspect, the ceramic precursor can have a particle size distribution such that greater than 20% of the particles have an equivalent spherical diameter of less than 0.25 microns as measured by Sedigraph. For example, the ceramic precursor can have a particle size distribution such that greater than 25%, greater than 30%, or greater than 40% of the particles have an equivalent spherical diameter of less than 0.25 microns as measured by Sedigraph. In another example, the ceramic precursor includes kaolin that has a particle size distribution such that between 20% and 60% of the particles have an equivalent spherical diameter of less than 0.25 microns as measured by Sedigraph, such as for example such that from 20% to 30%, 20% to 40%, from 20% to 50%, or from 40% to 60% of the particles have an equivalent spherical diameter of less than 0.25 microns as measured by Sedigraph.

In another aspect, the ceramic precursor can have a particle size distribution such that not greater than 10% of the particles have an equivalent spherical diameter of greater than 10 microns as measured by Sedigraph. For example, the ceramic precursor can have a particle size distribution such that not greater than 5% or not greater than 2% of the particles have an equivalent spherical diameter of greater than 10 microns as measured by Sedigraph. In another example, the ceramic precursor includes kaolin that has a particle size distribution such that between 0.1% and 10% of the particles have an equivalent spherical diameter of greater than 10 microns as measured by Sedigraph, such as for example such that from 0.5% to 10%, 1% to 5%, from 2% to 5%, or from 2% to 10% of the particles have an equivalent spherical diameter of greater than 10 microns as measured by Sedigraph.

According to a further aspect, the kaolin clay may have an Al₂O₃ content ranging from about 42% by weight to about 46% by weight on a fired basis, for example, an Al₂O₃ content ranging from about 43% by weight to about 45% by weight on a fired basis.

According to some embodiments, the ceramic precursor can include a kaolin clay may include a K₂O content ranging from about 0.005% by weight to about 0.23% by weight. For example, the kaolin clay may include a K₂O content ranging from about 0.1% by weight to about 0.2% by weight. Although not wishing to be bound by theory, it is believed that K₂O provides an indicator of the presence of mica in the kaolin clay. Mica is generally associated with a high shape factor, which leads to a high viscosity of a kaolin clay slurry.

In another aspect platy and potassium-bearing kaolin components can be included to disrupt the ceramic structure and create internal porosity. The platy and potassium-bearing kaolin components can be blended with other kaolin crude components to yield potassium oxide levels >0.1 wt. % on a fired basis, whereas typical high firing ceramic proppant green pellets have potassium oxide levels <0.1 wt. % fired basis. The platy and potassium-bearing kaolin components used for blending can have potassium oxide levels >0.2 wt. % on a fired basis.

In another aspect, the ceramic precursor comprises a kaolin clay having a shape factor of less than about 15, or less than about 10. For example, the shape factor may range from about 2 to about 15, from about 2 to about 10, or from about 5 to about 8.

A kaolin product of relatively high shape factor may be considered to be more “platey” than a kaolin product of low shape factor, which may be considered to be more “blocky.” “Shape factor” as used herein is a measure of an average value (on a weight average basis) of the ratio of mean particle diameter to particle thickness for a population of particles of varying size and shape, as measured using the electrical conductivity method and apparatus described in GB No. 2,240,398, U.S. Pat. No. 5,128,606, EP No. 0 528 078, U.S. Pat. No. 5,576,617, and EP 631 665, and using the equations derived in these publications. For example, in the measurement method described in EP No. 0 528 078, the electrical conductivity of a fully dispersed aqueous suspension of the particles under test is caused to flow through an elongated tube. Measurements of the electrical conductivity are taken between (a) a pair of electrodes separated from one another along the longitudinal axis of the tube, and (b) a pair of electrodes separated from one another across the transverse width of the tube, and by using the difference between the two conductivity measurements, the shape factor of the particulate material under test is determined. “Mean particle diameter” is defined as the diameter of a circle, which has the same area as the largest face of the particle.

BET surface area refers to the technique for calculating specific surface area of physical absorption molecules according to Brunauer, Emmett, and Teller (“BET”) theory. BET surface area may be measured by any appropriate measurement technique. In one aspect, BET surface area can be measured with a Gemini III 2375 Surface Area Analyzer, using pure nitrogen as the sorbent gas, from Micromeritics Instrument Corporation (Norcross, Ga., USA).

In another aspect, the slurry includes at least one dispersant. In one aspect, the slurry includes not more than 0.05% polymeric anionic dispersant, such as for example not more than 0.04% or not more than 0.03% polymeric anionic dispersant. In another aspect, the slurry can include from 0.5%-1% by weight of alkali silicate.

In one aspect, the polymeric anionic dispersant can include a polyacrylate, such as sodium polyacrylate. In another aspect, the polymeric anionic dispersant can include a polymethacrylate. In another aspect, the dispersant can include a copolymer of acrylate and a second compound, such as for example a maleic/acrylic copolymer.

According to yet another aspect, the crush strength measured under ISO 13503-2 of the sintered ceramic proppant at 7,500 psi may be less than about 10% fines by weight, for example for a 30/50 mesh size proppant. For example, the crush strength measured under ISO 13503-2 of the sintered ceramic proppant at 7,500 psi may be less than about 6% fines by weight, or less than about 4% fines by weight.

The strength of a proppant may be indicated from a proppant crush resistance test described in ISO 13503-2: “Measurement of Properties of Proppants Used in Hydraulic Fracturing and Gravel-packing Operations.” In this test, a sample of proppant is first sieved to remove any fines (i.e., undersized pellets or fragments that may be present), then placed in a crush cell where a piston is then used to apply a confined closure stress of some magnitude above the failure point of some fraction of the proppant pellets. The sample is then re-sieved and the weight percent of fines generated as a result of pellet failure is reported as percent crush. A comparison of the percent crush of two equally sized samples is a method of gauging the relative strength of the two samples.

According to one aspect, the method of forming ceramic proppants may further include pelletizing the ceramic precursor using a “wet” method, such as for example using a spray fluidizer. In one aspect, this may comprise feeding a slurry of ceramic precursor into a spray-fluidizer and operating the spray-fluidizer to form green pellets. According to still another aspect, the method may further include sintering the green pellets to form the ceramic proppants. According to still a further aspect, the method may further include sizing the sintered pellets to form the ceramic proppants.

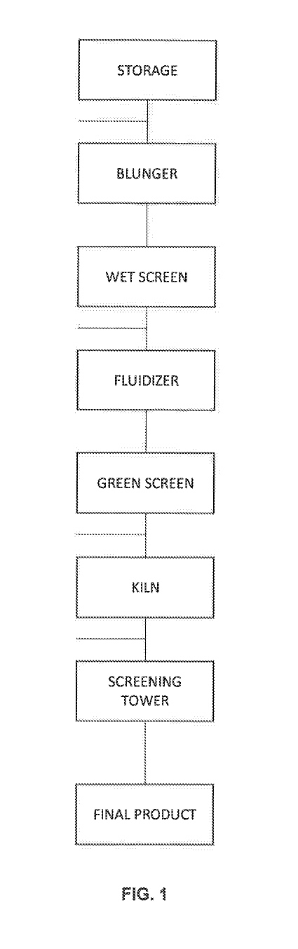

FIG. 1 is a schematic diagram of an exemplary process for making sintered ceramic proppants consistent with a “wet” exemplary method as disclosed herein. As shown in FIG. 1, a feed ceramic precursor comprising kaolin clay is transferred from storage to a blunger for blunging in a conventional manner known to those skilled in the art with inorganic or organic dispersant (e.g., TSPP, SHMP, Na-polyacrylate, and/or similar dispersants). Thereafter, the blunged feed ceramic precursor is wet-screened and degritted, after which the degritted feed ceramic precursor is fluidized for agglomeration. According to some embodiments, agglomeration may be performed using a spray fluidizer such as, for example, a fluidizer marketed by NIRO. Following agglomeration, the feed ceramic precursor is green-screened, and undersized material is recirculated to the fluidizer to serve as seeds. According to some embodiments, 35 mesh screen may be used. Thereafter, the feed ceramic precursor may be sintered in a kiln. For example, the feed may be heated in a kiln with the temperature being increased at a rate of, for example, 40° C. per minute until it reaches a temperature of, for example, 1,300° C. According to some embodiments, this temperature may be maintained for, for example, about an hour, and thereafter, the temperature may be reduced at a rate of, for example, about 5° C. per minute. Thereafter, the sintered and cooled material may be fed to a screening tower to classify the sintered material into different grades (e.g., oversized, undersized, and dust). Thereafter, the final sintered ceramic proppant may be obtained.

In another aspect, the pelletizing can be accomplished using a “dry” method, in which the feed material is raw ceramic precursor material is ground, pelletized and screened without first being slurried. In a dry process, the pelletization can be accomplished using any of a variety of pelletizing techniques that should be familiar to one of skill in the art, such as for example using an Eirich mixer or a pan pelletizer.

According to another aspect, the ceramic precursor may include a blend of a first kaolin clay having a particle size distribution such that greater than 90% of the particles have an equivalent spherical diameter of less than 2 microns as measured by Sedigraph and a second kaolin clay having a particle size distribution of the kaolin clay is such that from 82% to 94% of the particles have an equivalent spherical diameter of less than 2 microns as measured by Sedigraph.

According to another aspect, the ceramic precursor may include a blend of a first kaolin clay including not greater than about 46% by weight Al₂O₃ and a second kaolin clay including greater than about 47% by weight Al₂O₃. For example, the second kaolin clay may have an Al₂O₃ content ranging from about 49% to about 55%, or from about 50% to about 53%. The blend may include at least about 10% by weight of the first kaolin clay, for example, at least about 25% by weight of the first kaolin clay.

According to still another aspect, the ceramic precursor may include a blend of a first kaolin clay including less than about 0.1% by weight K₂O and a second kaolin clay including greater than about 0.1% by weight K₂O. The blend may include at least about 10% by weight of the first kaolin clay, for example, at least about 25% by weight of the first kaolin clay.

According to yet another aspect, the ceramic precursor may include a blend of a first kaolin clay having a shape factor of less than about 15 and the second kaolin clay having a shape factor of greater than about 20.

Another aspect of the invention relates to the novel process chemistry used to formulate the proppant for production in the wet process. In the conventional wet process a ceramic precursor feed, such as kaolin or bauxitic kaolin, is blunged into a mineral-water slurry using a pH adjuster (e.g., ammonium hydroxide) and a dispersant (e.g., sodium polyacrylate). The ceramic precursor slurry is then degritted using single or multiple process equipment (screens, hydrocyclones, spiral classifiers, centrifuges, etc. . . . ) to remove sand-sized particles comprised of quartz, mica, cemented clay agglomerates, and other ancillary minerals. A binder can be added to the clay slurry after degritting and prior to spray fluidized to form green pellets that are then presented to the sintering kiln. The binder may be for example a PVA, high molecular weight copolymer, starch, bentonite or other compound. The green pellets can be screened to a target particle size distribution prior to the kiln and the sintered particles are screened to a specific particle size distribution suitable for oilfield applications (reference ISO 13503-2).

According to some embodiments, the binder may include methyl cellulose, polyvinyl butyrals, emulsified acrylates, polyvinyl alcohols, polyvinyl pyrrolidones, polyacrylics, starch, silicone binders, polyacrylates, polyethylene imine, lignosulphonates, phosphates, alginates, and combinations thereof.

In one aspect of the present invention, sodium silicate can be used to replace all chemicals normally used for pH adjustment, dispersion and binder in a wet process. However, low doses of sodium polyacrylate may also be useful to reduce blunging time. The sodium silicate can act as a pH adjuster, dispersant, binder and fluxing agent when added in the correct dose range of about 10 to 30 or more pounds per dry ton of kaolin. The optimum firing temperature may typically be near the density minimum obtained by running a firing curve. The sodium silicate also helps to flux the pellet during sintering and increase the pellet's crush strength.

For example, according to some embodiments, a method of making a sintered ceramic proppant may include providing a ceramic precursor comprising kaolin clay, wherein the kaolin clay may include an Al₂O₃ content of not greater than about 46% by weight on a fired basis, and a K₂O content no greater than 0.23% by weight on a fired basis. The kaolin clay may have a particle size distribution such that greater than 65% of the particles have an equivalent spherical diameter of less than 0.5 microns as measured by Sedigraph, and a shape factor less than about 22. The method may further include blunging the kaolin clay, agglomerating the kaolin clay, and sintering the agglomerated kaolin clay to produce a sintered ceramic proppant.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

### EXAMPLES

### Example 1

Sample 1, a blended East Georgia fine kaolin feed, was dispersed with 18 lbs/dst sodium silicate (PQ Corporation, N-silicate) and 2 lbs/dst of a mid-range molecular weight sodium polyacrylate (Bulk Chemical Services, LLC. BCS 4010, “as received” basis, 43% solids) that was added during blunging. The kaolin slurry was then spray fluidized in an Applied Chemical Technology (ACT) spray fluidizer to form green pellets that were fired at a range of different temperatures from 1250° C. to 1400° C. Fired ceramic pellet samples were obtained by being passed through a 30 mesh but retained on 50 mesh (i.e., “30/50”).

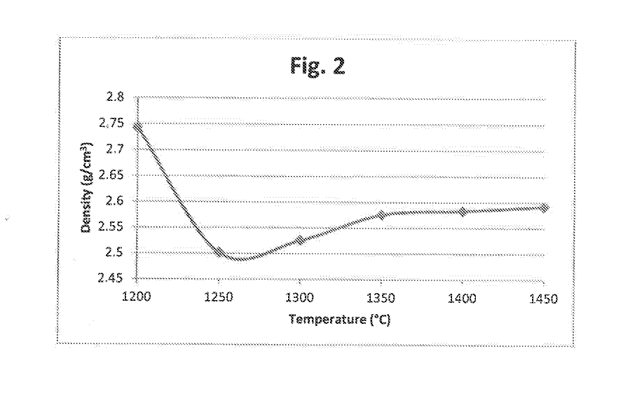

The resulting absolute density of the pellets after firing over the range of temperatures tested is shown in FIG. 2. It is hypothesized that the decrease in observed bulk density observed when firing at temperatures between about 1200° C. and about 1250° C. is due to the closing of pore throats by glassy phases made by the partial melting of grain contacts in the presence of alkalis. The density observed when firing at temperatures in excess of 1300° C. is hypothesized to be due to recrystallization and densification of the pellets by loss of internal porosity.

Sample 1 pellets that had been fired at 1300° C. were then tested in accordance with ISO 13503-2 and found to have a crush strength of 1.7% fines generated @ 4 k psi and 5.3% fines generated @ 7.5 k psi. The pellets were also observed to have an absolute density of 2.50 g/cc and a bulk density of 1.33 g/cc.

For sample 2, the same kaolin feed was dispersed with 24 lbs/dst sodium silicate and 2 lbs/dst sodium polyacrylate spray fluidized to form green pellets that were fired at 1300° C. and screened to 30/50.

Sample 2 was then tested in accordance with ISO 13503-2 and found to have a crush strength of 1.7% fines generated @ 4 k psi and 5.5% fines at 7.5K psi.

Conductivity of Sample 2 was measured using the PropTest PS50 Long Term Conductivity Test (similar to ISO 13503-5), and the results are summarized in Table 1 below. The measured conductivity of Sample 2 was significantly superior to the measured conductivity of conventional natural white sand and brown sand controls.

TABLE 1

| | 1K PSI (Initial) | 6K PSI (Final) | 8K PSI (Final) |
|---|---|---|---|
| Sample 2 | 6598 | 2609 | 939 |
| Natural White Sand | 3170 | 1211 | 589 |
| Brown Sand | 3938 | 568 | 147 |

### Example 2

In another test, three samples (samples 3, 4 & 5) of fired ceramic pellets were prepared from a blend of four kaolins having the following physical characteristics as shown in Table 2 below.

TABLE 2

| | | Sedigraph PSD | | | | | |
|---|---|---|---|---|---|---|---|
| | Shape | | | | | 0.5 | 0.25 |
| Name | factor | 10 um | 5 um | 2 um | 1 um | um | um |
| East Georgia | 7.4 | 96.5 | 95.5 | 92.7 | 90.0 | 80.8 | 53.7 |
| Fine Blocky | | | | | | | |
| Kaolin 1 (20%) | | | | | | | |
| East Georgia | 7.7 | 94.3 | 89.5 | 82.8 | 78.0 | 68.0 | 44.6 |
| Fine Blocky | | | | | | | |
| Kaolin 2 (20%) | | | | | | | |
| East Georgia | 7.1 | 98.4 | 97.0 | 93.7 | 89.5 | 78.3 | 48.2 |
| Fine Blocky | | | | | | | |
| Kaolin 3 (40%) | | | | | | | |
| East Georgia | 21.7 | 98.3 | 96.9 | 90.0 | 82.5 | 69.9 | 44.0 |
| Fine Platy | | | | | | | |
| Kaolin (20%) | | | | | | | |

The blend consisted of 40% East Georgia Fine Blocky Kaolin 2, plus 20% each of East Georgia Fine Blocky Kaolin 1, East Georgia fine Blocky Kaolin 2, and East Georgia Fine Platy Kaolin samples. Sample 3 was dispersed with 18 lbs/dst sodium silicate (PQ Corporation, N-silicate) and 2 lbs/dst of mid-range molecular weight sodium polyacrylate (Bulk Chemical Services, LLC. BCS 4010, “as received” basis, 43% solids) that was added during blunging. Samples 4 & 5 were prepared as Sample 2, but included 24 and 30 lbs/dst sodium silicate respectively.

Fired ceramic pellets were formed and fired generally as described in Example 1 above. The sintered ceramic pellets displayed the following final pellet chemistry as assessed by XRF (shown in Table 3):

TABLE 3

| | | Fired Basis | | | | | | | | |
|---|---|---|---|---|---|---|---|---|---|---|
| | Total | Fe2O3 | MgO | Al2O3 | SiO2 | TiO2 | CaO | Na2O | K2O | P2O5 |
| Sample | (%) | (%) | (%) | (%) | (%) | (%) | (%) | (%) | (%) | (%) |
| Sample 3 | 100.0 | 1.11 | 0.07 | 45.16 | 50.49 | 2.63 | 0.06 | 0.28 | 3.13 | 0.07 |
| Sample 4 | 100.0 | 1.09 | 0.06 | 44.94 | 50.70 | 2.63 | 0.05 | 0.34 | 0.12 | 0.07 |
| Sample 5 | 100.0 | 1.06 | 0.08 | 44.92 | 50.66 | 2.62 | 0.05 | 0.42 | 0.13 | 0.07 |

The resulting 30/50 mesh fraction was recovered and tested in accordance with ISO 13503-2. Sample 3 was found to have a crush strength of 5.3% fines generated @ 7.5 k psi, Sample 4 a crush strength of 4.3% fines generated @ 7.5 k psi, and Sample 5 a crush strength of 4.4% fines generated @ 7.5 k psi. All three samples illustrate that a suitable intermediate strength proppant can be produced in accordance with the methods described herein.

### Example 3

A blended kaolin feed, was dispersed with 24 lbs/dst sodium silicate (PQ Corporation, N-silicate) and 2 lbs/dst of a mid-range molecular weight sodium polyacrylate (Bulk Chemical Services, LLC. BCS 4010, “as received” basis, 43% solids) that was added during blunging. The blend include 33.3% of each three kaolins having physical characteristics as summarized in Table 4 below.

TABLE 4

| | Shape | Sedigraph PSD | | | | | |
|---|---|---|---|---|---|---|---|
| Name | factor | 10 um | 5 um | 2 um | 1 um | 0.5 um | 0.25 um |
| East Georgia Fine | 7.7 | 94.3 | 89.5 | 82.8 | 78.0 | 68.0 | 44.6 |
| Blocky Kaolin 2 | | | | | | | |
| (33.3%) | | | | | | | |
| East Georgia Fine | 7.1 | 98.4 | 97.0 | 93.7 | 89.5 | 78.3 | 48.2 |
| Blocky Kaolin 3 (33.3%) | | | | | | | |
| Fine Platy East Georgia | 21.7 | 98.3 | 96.9 | 90.0 | 82.5 | 69.9 | 44.0 |
| Kaolin (33.3%) | | | | | | | |

Fired ceramic pellets were formed and fired generally as described in Example 1 above. The resulting 30/50 mesh fraction was recovered and tested in accordance with ISO 13503-2. The resulting 30/50 mesh sintered pellets were collected after sintering at a range of temperatures between 1250° C. and 1450° C. Bulk density, absolute density and crush strength in accordance with ISO 13503-2 of these pellets are shown in Table 4 below.

Table 5 shows characteristics of product fired to different temperatures. The absolute density has a minimum between 1250 and 1350 C, whereas the wt. % fines generated at 7.5 k psi for samples fired greater than or equal to 1300 C is less than the published value of 8.8 wt. % fines generated for Northern White Frac Sand (FairmontSantrol) 30/50 at 7.0 k psi. The typical absolute density for natural frac sand is 1.65 g/cm³ and the typical bulk density is 1.49 to 1.56 g/cm³.

TABLE 5

| | Bulk | Absolute Density | | Crush at 7.5k | | Crush at 10k | |
|---|---|---|---|---|---|---|---|
| Temp | Density | (g/cm³) | | Crush | std. | Crush at | std |
| (° C.) | (g/cm³) | Density | Std. Dev. | at 7.5k | dev. | 10k | dev. |
| 1450 | 1.3941 | 2.5859 | 0.0001 | | | | |
| 1400 | 1.3828 | 2.5677 | 0.0002 | 3.38 | 0.01 | | |
| 1350 | 1.3617 | 2.5245 | 0.0004 | 4.28 | 0.08 | 8.09 | 0.27 |
| 1300 | 1.3258 | 2.5201 | 0.0024 | 6.23 | 0.33 | 12.41 | 0.19 |
| 1250 | 1.2564 | 2.6525 | 0.0019 | 9.60 | 0.13 | 18.01 | 0.14 |

1. A method of preparing a sintered ceramic proppant, the method comprising:
providing a ceramic precursor material comprising kaolin clay, 0.2%-2% by weight alkali silicate, and not more than 0.05% by weight polymeric anionic dispersant;
pelletizing the ceramic precursor; and
sintering the ceramic precursor pellets for form a sintered ceramic proppant having a specific gravity ranging from 2.40 to 2.57.

2. The method of claim 1, wherein the particle size distribution of the kaolin clay is such that greater than 85% of the particles have an equivalent spherical diameter of less than 2 microns as measured by Sedigraph.

3. (canceled)

4. The method of claim 1, wherein the particle size distribution of the kaolin clay is such that greater than 20% of the particles have an equivalent spherical diameter of less than 0.25 microns as measured by Sedigraph.

5. (canceled)

6. The method of claim 1, wherein the particle size distribution of the kaolin clay is such that greater than 30% of the particles have an equivalent spherical diameter of less than 0.25 microns as measured by Sedigraph.

7. (canceled)

8. The method of claim 1, wherein the particle size distribution of the kaolin clay is such that not greater than 10% of the particles have an equivalent spherical diameter of greater than 10 microns as measured by Sedigraph.

9. (canceled)

10. (canceled)

11. The method of claim 1, wherein the kaolin clay has an Al₂O₃ content ranging from about 42% by weight to about 46% by weight.

12. The method of claim 1, wherein the kaolin clay comprises a K₂O content ranging from about 0.005% by weight to about 0.08% by weight.

13. (canceled)

14. The method of claim 1, wherein the kaolin clay has a shape factor of less than about 15.

15. The method of claim 1, wherein the kaolin clay has a BET surface area of greater than about 15 m²/g.

16. The method of claim 1, wherein the slurry includes not more than 0.3% polymeric anionic dispersant.

17. (canceled)

18. (canceled)

19. The method of claim 1, wherein 0.5%-1% by weight of the alkali silicate is present in the slurry.

20. The method of claim 1, wherein the sintered ceramic proppant has a specific gravity greater than about 2.50.

21. The method of claim 1, wherein the sintered ceramic proppant has a specific gravity less than about 2.50.

22. The method of claim 1, wherein the sintered ceramic proppant has a bulk density ranging from about 1.25 g/cm³ to about 1.45 g/cm³.

23. (canceled)

24. The method of claim 1, wherein the crush strength measured under ISO 13503-2 of the sintered ceramic proppant at 7,500 psi is less than about 10% fines by weight.

25. (canceled)

26. The method of claim 1, wherein the pelletizing is accomplished using a spray fluidizer.

27. The method of claim 1, wherein the pelletizing is accomplished using an Eirich mixer.

28. The method of claim 1, wherein the kaolin clay comprises a blend of a first kaolin clay having a particle size distribution such that greater than 90% of the particles have an equivalent spherical diameter of less than 2 microns as measured by Sedigraph and a second kaolin clay particle size distribution of the kaolin clay is such that from 82% to 94% of the particles have an equivalent spherical diameter of less than 2 microns as measured by Sedigraph.

29. The method of claim 28, wherein the first kaolin clay has a shape factor of less than about 15 and the second kaolin clay has a shape factor of greater than about 20.

30. The method of claim 1, wherein the ceramic proppant is sintered at a temperature ranging from about 1200 degrees C. to about 1400 degrees C.
